(19) United States
(12) Patent Application Publication
(10) Pub. No.: US 2015/0158262 A1
(43) Pub. Date: Jun. 11, 2015

(54) METHOD AND DEVICE FOR ADAPTIVELY CONTROLLING A HYDRAULIC PRESS

(71) Applicant: Dieffenbacher GmbH Maschinen-und Anlagenbau, Eppingen (DE)

(72) Inventors: Matthias Graf, Bretten (DE); Bernd Bodenstein, Eppingen (DE)

(73) Assignee: Dieffenbacher GmbH Maschinen-und Anlagenbau, Eppingen (DE)

(21) Appl. No.: 14/399,856

(22) PCT Filed: May 7, 2013
(86) PCT No.: PCT/EP2013/059522

§ 371 Date: Nov. 7, 2014

(30) Foreign Application Priority Data
May 10, 2012 (DE) 10 2012 104 124.5

(51) Int. Cl. B30B 15/16; F15B 11/064

(52) U.S. Cl. CPC B30B 15/163; F15B 11/064

(57) ABSTRACT

A method and apparatus for adaptively controlling a hydraulic press comprising a hydraulic drive unit for lifting and lowering a press ram. A piston chamber of the drive unit can be connected to a hydraulic accumulator formed by at least two groups of storage bottles, the connection established by hydraulic pipes that allows an expandable volume, stored in the storage bottles to supply the energy required for the press to perform a working stroke. Different filling pressures can be established in the storage bottles. A hydraulic accumulator can be adjusted to three operating modes, allowing a press controller to automatically analyze utilization and accordingly block individual groups or compartments of storage bottles, transfer the gas between storage bottles during a charging process at the end of the cycle, or adjust individual groups of storage bottles to different pressure levels. Advantageously, these three scenarios entail no waiting or transfer time.

The invention relates to a method for operating a hydraulic press used for the primary shaping, reshaping, punching or processing of materials or workpieces such as plastic moulding compounds, deep-drawing sheets, forged pieces or the like, comprising a hydraulic drive unit for lifting and lowering a press ram according to the preamble of claim 1, and an apparatus, especially according to the preamble of the apparatus claim 10.

In the case of hydraulic presses, the press ram is connected to one or several piston-cylinder units. Relevant parameters of the hydraulic drive are represented by the pressure and the flow rate of the pressure medium. Both parameters can be adjusted to the respective working process via respective pumps and control devices (power, pressure and lifting controllers).

Depending on the type of the drive, one distinguishes between hydraulic presses with direct pump drive and hydraulic presses with storage drive.

In the case of direct drive, a constant or variable displacement pump (hydraulic pump) which is driven by an electric motor acts on the main working cylinder, which is supplied with pressure medium for generating the pressing force on the large cylindrical piston surface and for lifting the ram on the smaller ring surface of the piston of the piston-cylinder unit. The pump and the drive motor must always be designed for the greatest power requirements of the press. The high-pressure pump can be arranged as a variable displacement pump or as an adjustable hydraulic pump in order to set a continuous adjustment of the delivery quantity and thus the ram speed. A large liquid quantity is therefore conveyed at low pressure and the pressing tool is thus provided with a large speed and vice versa. This is useful for a rapid stroke as a rapid traverse and for high application of force during the reshaping process. It is disadvantageous however that the drive power of the pump changes continuously between zero and a maximum value. This leads to considerable loads on the grid. It is further disadvantageous with respect to the direct drive that the potential energy of the ram and the downwardly moved masses of the system remain unused, because the pressure medium flowing from the ring cylinder during the downward movement of the piston is merely discharged via a directional control valve to a tank or oil container.

Another drive variant for hydraulic presses is the storage drive. In this case, a constantly conveying pump which is driven by an electric motor conveys at first to a high-pressure storage unit, from which the working cylinder is supplied with the storage pressure via a proportional valve. This high storage pressure is always available during the entire working stroke. The increase in power from the reshaping process usually occurs slowly within the working stroke and mostly increases progressively with increasing stroke. The storage pressure of the reservoir storage unit decreases continuously with increasing extraction from the volume. As a result, a very high storage pressure is initially available in the initial working stroke phase in which only low working pressures are demanded.

In the case of a storage drive, energy is stored in form of compressed gas (nitrogen) in storage cylinders prefilled with nitrogen for example. During the working process of a press, there is a pressure curve in each cycle which increases over the time axis from zero to the working pressure caused by the process. In the phases where the momentarily required working pressure is lower than the pressure in the storage cylinders, the excess energy is converted via the control valve or other throttling losses in a useless manner into heat. The produced heat then needs to be dissipated via the cooling system (further consumption of energy).

A method for operating a hydraulic press is known from DE 195 28 558 B4, in which the piston chamber of the cylinder of the drive unit is connected by hydraulic pipelines via a safety block, proportional valve and non-return valve to a hydraulic storage unit in such a way that the volume of the piston chamber of the cylinder is transmitted to the hydraulic storage system unit during the downward travel of the press ram, and the energy stored in the hydraulic storage unit is utilised by a release valve for supplying power to hydraulic consumers which operate at lower hydraulic pressure than the drive unit.

The advantages of the storage drive in comparison with the pump drive are especially the lower connected load, the more even network load and the high and rapid supply of power. In addition to these advantages, the storage drive comes with the disadvantage that it needs to be designed to meet the maximum force of the cylinder. Variable forces usually act on the press cylinder depending on the spectrum of the parts, i.e. low forces in the case of small parts and high forces in the case of large parts. If small parts are produced on a press for example which require only low forces, the storage unit still needs to be charged to the pressure level which is required for maximum force. If low forces are required and the volume for supplying the press cylinder is taken from the highly loaded storage unit, high pressure drops are produced by the hydraulic control unit. They are converted into heat. The heat must be removed from the hydraulic system with a respective input of energy. The volume for the next cycle must be pumped up with respective power to the high pressure level. Current storage drives therefore operate uneconomically in part-load operation. The same applies to the extracted volume quantity. The reservoir storage unit is designed for the maximum withdrawal volume, according to the maximum working stroke. Many parts will then be reshaped in practice at a lower working stroke. Since the pressure in the storage unit will not decrease to such an extent in the case of a lower extraction quantity, a higher difference remains between the storage pressure and the required working pressure, so that far more energy needs to be applied during charging as would normally be necessary.

The invention is based on the object of providing a method for operating a hydraulic press which is improved in relation to the state of the art and is especially more economical, and of providing a pertinent press in which the storage drive is ideally adjusted with respect to the filling state and its energy delivery characteristics to the respective requirements of the workpieces to be produced, i.e. the working force progression (path/pressure over time) required for primary shaping or reshaping. In particular, a method for the adaptive (self-learning) control of a hydraulic press which is improved over the state of the art shall be provided.

This object is achieved with respect to the method by the features of claim 1 and with respect to the apparatus by the features of claim 10. Advantageous embodiments and further developments which can be used individually or in combination with each other are the subject matter of the dependent claims. The apparatus can be used separately but also especially for performing the method.

The present invention is based on the idea of dividing the downstream connection of an expansion volume stored by gas compression into groups of storage cylinders with different filling pressures.

In particular, groups of storage cylinders have proven their worth which are filled in a graduated manner to the lowest possible pressure which is adjusted to the respective production requirements which are mainly characterized by the working pressure curve and extraction volume, ideally especially with respect to energy efficiency.

Preferably, the one group of storage cylinders can be blocked off in relation to the other group of storage cylinders in a first operating mode in which the press is operated at a lower pressing force or a lower working stroke, which corresponds to a decrease in the storage volume. It is the preferred goal in this case to mainly reduce the storage volume to such an extent that at the end of a working stroke of the press the still required working pressure is reached. This leads to the advantage of a reduced need for energy for charging one or several groups of storage cylinders, because the mean charging pressure is lower. The lowest level of the increase in efficiency is realised with the first operating mode. It is well suited for part-load operation.

Preferably, gas can be pumped from an active group of storage cylinders to a non-active group of storage cylinders in a second operating mode, in which the press requires a lower operating pressure or a lower extraction quantity. The active group or groups of storage cylinders can thus advantageously be filled by refilling gas quantities to the operationally required charging pressure and operate in an energy-efficient way. The second operating mode offers improved energy efficiency in comparison with the first operating mode. The second operating mode is also well suited for part-load operation.

A third operating mode is preferred in a further embodiment of the invention, in which the group of storage cylinders with the lowest filling pressure is connected at first to the piston chamber of the cylinder and, with rising working stroke, the group of storage cylinders with the next higher filling pressure and/or the further group of storage cylinders are operatively connected in a sequential manner with successively higher filling pressures. The third operating mode utilises the entire available volume of the hydraulic storage unit in a cascaded form. The volume of the hydraulic storage unit can be adjusted ideally to the working stroke characteristics by means of a sufficiently high number of groups of pressure-graduated storage cylinders. This leads to significant savings in energy even in full-load operation of the press and therefore advantageously to the best possible energy efficiency.

The activation of the next higher pressure-filled group of storage cylinders can occur shortly before reaching the pressure equalisation between the storage pressure and the working pressure in the piston chamber of the cylinder or when falling beneath the required working stroke speed of the piston.

In particular, activation of the next higher filled group of storage cylinders is preferable in which the previously used group of storage cylinders is closed or closes automatically via a releasable non-return valve, especially when the storage pressure of the activated group of storage cylinders is greater than the remaining storage pressure in the previously used group of storage cylinders.

It is preferable in a further embodiment of the invention that the kinetic energy of a rapid closing movement of a ram is braked via the closing cylinders before reaching a working stroke starting position, and the displacement volume and the braking pressure are used for filling the groups of storage cylinders, especially the groups with low required filling pressure.

A press control unit is finally preferably provided in accordance with the invention, which automatically analyses the capacity utilisation of the press and controls the same according to the required operating mode. In this process, the first operating mode requires very low level of intelligence in the control. All storage units are charged equally and only individual groups of storage cylinders are selected or deselected. The control of the second operating mode can preferably be performed adaptively (in a self-learning fashion) after the first cycle, optionally in a stepwise fashion. In contrast to this, the third operating mode, in which cascaded (multi-step) groups of storage cylinders filled to different pressure levels are activated and deactivated as required according to the load-displacement/time characteristics of a working stroke of the press, requires high intelligence in the adaptive feedback control of the individual pressure levels.

The present invention finally also relates to an apparatus, especially for performing a method as described above.

It is possible with a hydraulic storage unit in accordance with the invention which can be adjusted to three different operating modes and consists of at least two groups of storage cylinders that after the start of production a press control unit analyses the capacity utilisation in a preferably automatic way and then accordingly blocks individual groups or even partitions of storage cylinders (operating mode 1), or refills the gas to the storage cylinders in the case of a charging process at the end of the cycle (operating mode 2), or adjusts the individual groups of storage cylinders to different pressure levels which are adjusted to the working stroke characteristics (operating mode 3). No waiting times or refilling times are advantageously required in all three cases.

The present invention provides a considerably more energy-efficient hydraulic press for primary shaping, reshaping, punching or processing of materials or workpieces such as plastic moulding compounds, deep-drawing sheets, forged pieces or the like, with which energy reclamation is possible, which can be utilised especially in the second and even more in the third operating mode in a highly efficient way, without having to provide a separate lower-pressure hydraulic storage unit which was previously required in the state of the art.

These and further features and advantages of the invention will be explained below in closer detail by reference to embodiments shown in the schematic drawings, wherein:

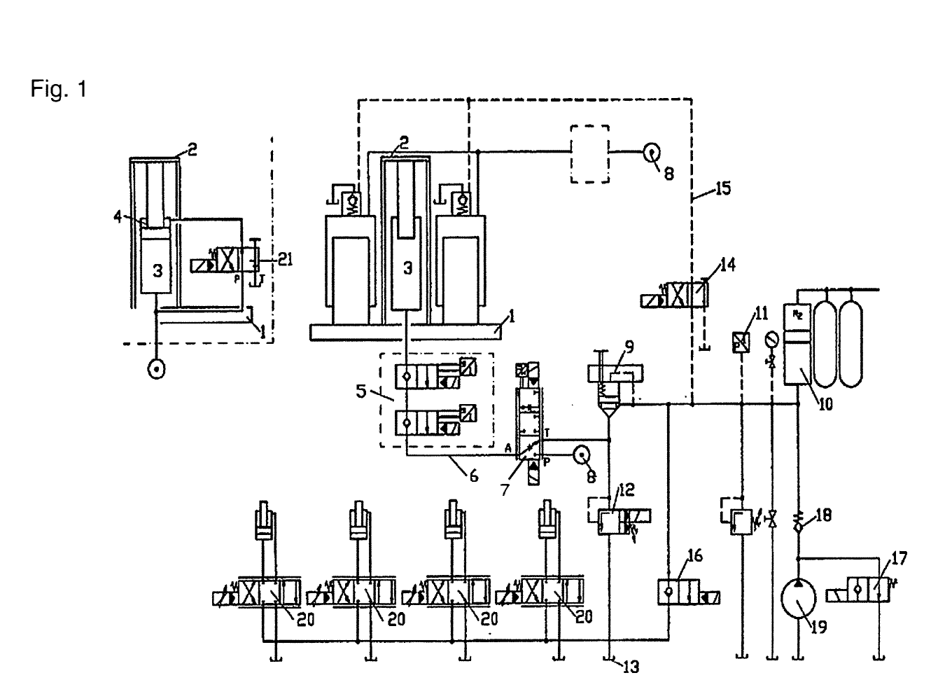

FIG. 1 shows a hydraulic circuit diagram according to the state of the art;

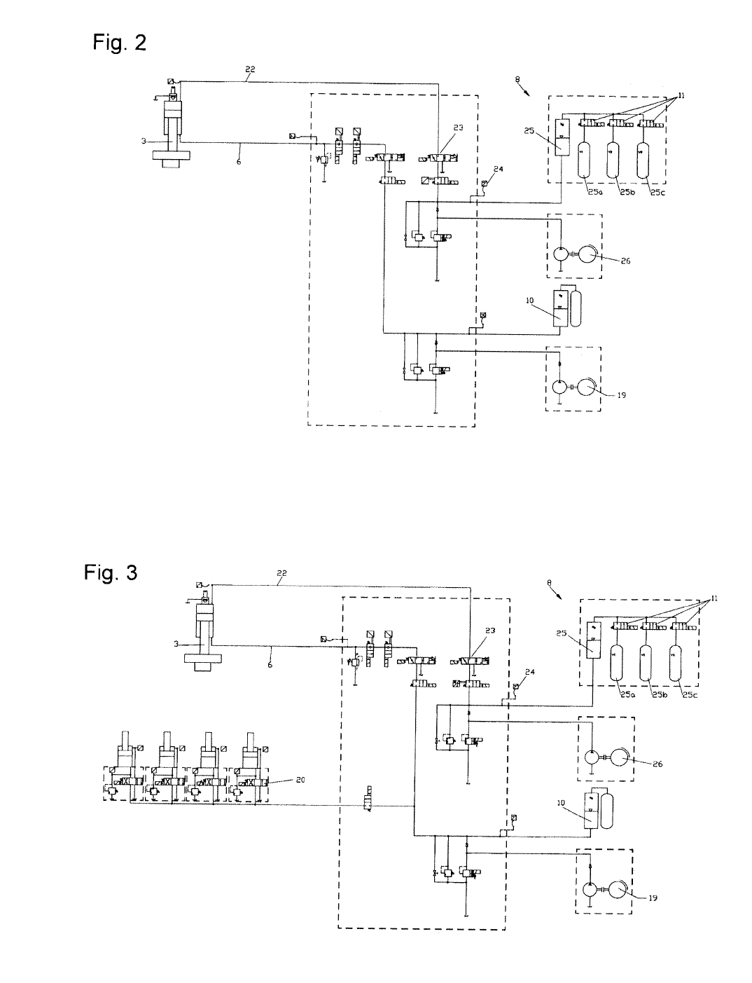

FIG. 2 shows a hydraulic circuit diagram according to a first embodiment of the invention;

FIG. 3 shows a hydraulic circuit diagram according to a second embodiment of the invention;

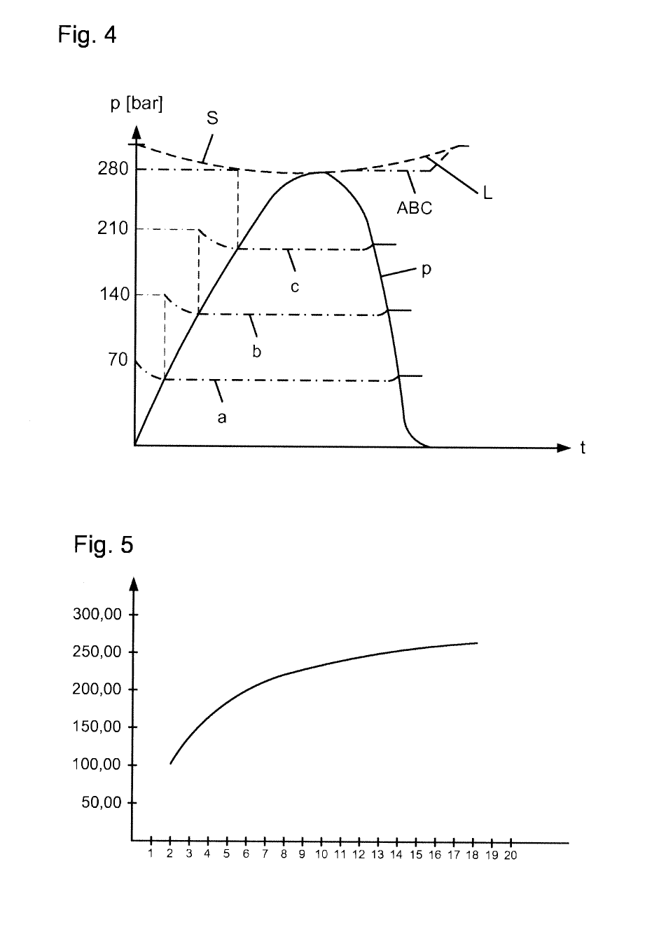

FIG. 4 shows the pressure curve with groups of storage cylinders in accordance with the invention, and

FIG. 5 shows the bottom operating pressure as a function of active groups of storage cylinders.

The same reference numerals designate the same components in the following description of the preferred embodiments.

FIG. 1 shows the hydraulic circuit diagram of a press known from the state of the art. As is shown in the illustration, the drive unit for the closing and opening process of the ram 1 in the press consists of the piston 2 and the cylinder 3 as the cylinder-piston unit, which is driven by means of an energy source 8. During the closing process, the piston 2 is pushed into the piston chamber of the cylinder 3 and the volume in the piston chamber is thus reduced. This volume must be guided via a pipeline 6 and a safety block 5. From the safety block 5, the volume is guided via the pipeline 6 to the connection A of a proportional valve 7. During the downward movement of the press, the proportional valve 7 is triggered in the illustrated position, which means the volume flow proceeds from A to T into the pipeline 6. The volume moves to a low-pressure hydraulic storage unit 10 via a non-return valve 9, which is actuated by the load energy pressure. The low-pressure hydraulic storage unit 10 is configured with respect to its volume in such a way that it can operate the auxiliary or secondary movements of the press. Once the low-pressure hydraulic storage unit 10 is filled, which is reported by a pressure gauge 11, a switching valve 12 is activated and the excess volume is diverted to a tank 13.

The thus stored energy in the low-pressure hydraulic storage unit 10 can be guided via the line with a release valve 16 to the secondary function and be utilised there. The hydraulic auxiliary circuit 20 for the cylinder units applies especially as a secondary function, which cylinder units can operate with a pressure level of 40 to 80 bar, as is the case for example in an illustrated hydraulic cushion as the press table. At the same time, this energy can also be used for a control oil system via a control oil line 15 and a control oil valve 14 as a control oil energy supply unit. The low-pressure hydraulic storage unit 10 must be filled prior to the first working cycle for the first charging process of the low-pressure hydraulic storage unit 10 by a hydraulic pump 19 via a non-return valve 18 with blocked bypass valve 17 through the pipeline for such a time until the pressure gauge 11 indicates the desired pressure level. This message is a precondition for the start of the machine.

The illustration of a differential circuit with volume utilisation is shown in FIG. 1 separated by way of a dot-dash line, which differential circuit further leads to the simplification of the hydraulic elements in addition to saving energy, e.g. by reducing the size of the pumps with respect to their volume, but also that of valves with respect to their volume throughput. The benefits can be seen during the start-up of the press, wherein the excess oil of the annular space 4 is also conveyed into the larger piston chamber of the cylinder 3. When the press travels upwardly via the cylinder-piston unit and pressurisation in the piston chamber of the cylinder 3, the volume is guided from the annular space 4 via the switching valve 21 back to the piston chamber of the cylinder 3. The thus recirculated quantity need not be conveyed by the energy supply unit. The advantage lies in the fact that the pumps are not required as the energy supply unit. It is a further advantage that the pumps thus do not need to provide the full volume as the energy supply unit which is required as the breakout force in the piston chamber of the cylinder 3 and which needs to be provided over the entire stroke. The valves situated after the pump also only need to cope with the residual quantity of volume. This provides cost savings, because the units can be provided with a size that is smaller than required up until now.

FIGS. 2 and 3 respectively show the hydraulic circuit diagram of a first or second embodiment of the invention.

As is shown, the piston chamber of the cylinder 3 of the drive unit is connected or connectable to a high-pressure hydraulic storage unit 25 via hydraulic pipelines 22, a proportional valve 23 and a release valve 20, which hydraulic storage unit forms a new energy-efficient drive or an energy source 8 of the press in addition to the hydraulic pump 26 (for charging).

The high-pressure hydraulic storage unit 25 is or can be subdivided in accordance with the invention into several groups 25a, 25b, 25c, . . . of storage cylinders in such a way that an expansion volume stored by gas compression in the groups 25a, 25b, 25c, . . . of storage cylinders directly or indirectly supplies the energy in form of a volume flow and pressure via a piston storage unit or a comparable media separator, which energy is required for a working stroke of the press.

All storage cylinders can be filled to the maximum operating pressure (e.g. 305 bar). If a lower operating pressure or a lower extraction quantity is required, i.e. the press is operated with a lower pressing force or a lower working stroke, a suitable valve control on the gas side in conjunction with “compressor operation” of the piston storage unit allows the filling pressure in one or several groups of cylinders 25a, 25b, 25c, . . . to decrease.

Groups 25a, 25b, 25c, . . . of storage cylinders have proven their worth which are filled in a graduated manner to the lowest possible pressure which is adjusted to the respective production requirements, mainly characterized by the working pressure progression and the extraction volume, especially ideally adjusted to energy efficiency.

In a first operating mode, in which the press is operated with a lower pressing force or a lower working stroke, the one group 25a, . . . of storage cylinders can preferably be blocked off with respect to the other group 25b, . . . of storage cylinders. If low forces are required on the ram, individual or several groups 25a, 25b, 25c, . . . of storage cylinders can be closed via shut-off valves. As a result, the pressure level in the storage unit 25 will decrease more strongly when pressure is extracted. This will now be illustrated by reference to an example: if a storage unit 25 were operated only with two instead of with 18 storage cylinders, the pressure level would drop at maximum extraction from regularly 305 bar to 105 bar. The subsequent charging of the storage unit occurs then from 105 bar to 305 bar, at an average pressure of 205 bar, instead of 290 bar as before.

Nitrogen or a comparable gas with which the storage cylinders are prefilled can advantageously be re-pumped from an active group 25a, . . . of storage cylinders to a non-active group 25b, . . . of storage cylinders in a second operating mode in which the press requires a lower operating pressure or a lower extraction quantity. The pressure level is reduced in a group of cylinders 25a . . . for example. The active piston storage unit is thus adjusted better to the required pressure level. Pressure losses are lower. The “superfluous” nitrogen is located in two groups of cylinders 25b and 25c which are closed. The nitrogen pressure is then at a higher level (e.g. maximally 350 bar) in these cylinders. This will be illustrated by reference to an example: if 10 out of 18 cylinders were decreased in their filling pressure from 305 bar to 205 bar and the removed nitrogen gas were intermediately stored in the remaining eight cylinders, the pressure would decrease from 205 bar to 105 bar during maximum extraction. The subsequent storage charging occurs then from 105 bar to 205 bar, with an average pressure of 155 bar, instead of 290 bar as before or 205 bar as in the aforementioned case of the first operating mode.

A third operating mode is preferred in a further embodiment of the invention, in which the group 25a . . . of storage cylinders with the lowest filling pressure is connected at first to the piston chamber of the cylinder, and with increasing working stroke the group 25b . . . of storage cylinders with the next higher filling pressure and/or the further group 25c . . . of storage cylinders is operatively connected with gradually higher filling pressures. This utilisation of the drive storage unit with groups that can be activated and deactivated advantageously allows the utilisation of the entire available volume in a cascaded (multistep) form. In this process, the individual groups 25a, 25b, 25c, . . . are filled to different pressure levels, and during the working stroke individual cylinder storage units or the group 25a . . . of storage cylinders with the lowest pressure level is switched to be active, whereas the remaining groups 25b, 25c, . . . remain closed. In the case of volume extraction, the pressure in the active group 25a of storage cylinders decreases and the working pressure in the cylinder increases. If the required working pressure approaches the residual pressure available in the active group 25a, . . . of storage cylinders, the group 25b . . . of storage cylinders that is the next higher one with respect to the filling pressure is activated and the last activated one is switched off. The third operating mode is again illustrated by reference to an example: if the filling pressure of six out of eighteen cylinders were decreased from 305 bar to 105 bar, further six cylinders were decreased from 305 bar to 205 bar, and the remaining six cylinders were left at 305 bar, a working cycle can be run in full-load operation in that the first third of the working stroke is extracted from the first group 25a . . . (pressure decrease from 105 bar to 90 bar), the second third from the second group 25b . . . with a pressure decrease from 205 bar to 180 bar and the third from the third group 25c . . . with a pressure decrease from 305 bar to 275 bar. The subsequent storage charging then occurs in the first group 25a . . . from 90 bar to 105 bar, in the second group 25b . . . from 180 bar to 205 bar, and in the third group 25c . . . from 275 bar to 305 bar. This then corresponds to an average pressure of 193 bar instead of the currently used 290 bar in full-load operation.

FIG. 3 shows an alternative embodiment according to the invention. In contrast to the embodiment shown in FIG. 2, FIG. 3 shows an auxiliary circuit 20 for cylinder units (as shown and described similar to FIG. 1), which cylinder units can operate at a pressure level of 40 to 80 bar, as is the case for example in the hydraulic cushions for a press table.

This system also offers the possibility for the first time to return energy back to the groups 25a, 25b, 25c, . . . of storage cylinders. If the ram 1 of the press is retarded during the pressing process, this currently occurs via the retraction cylinders, in that the control valves constrict the oil flow rate and thus convert the energy into heat. The braking pressure is 140 bar in the retraction cylinders for example.

As a result of the multistep groups 25a, 25b, 25c, . . . of storage cylinders, as proposed with the present invention, there is now the possibility to recirculate this displaced oil to the respective section in the hydraulic storage unit 25 and thus to make the energy available again for the next closing process. This was not possible until now because the hydraulic storage unit was always situated at a higher pressure level.

Similarly, the hydraulic oil displaced during the closing process in the table cushion can be recirculated to a known low-pressure hydraulic storage unit 10 and energy can thus be recovered.

In so far a decrease in the so-called PLL force also occurs for example with the proposed system of adjustable groups of storage cylinders, a known low-pressure hydraulic storage unit 10 can be provided for sufficient pressure supply for the retraction, which storage unit provides the functions in question.

It is understood that the storage cylinders of the low-pressure hydraulic storage unit 10, which are shown separately in FIGS. 2 and 3, can be a component or group of the high-pressure hydraulic storage unit 25.

FIG. 4 shows the pressure curve ABC with the groups 25a, 25b, 25c, . . . of storage cylinders. The illustration shows how a pressure curve which rises over the time axis from zero to the process-induced working pressure P occurs in the working process of a press in each cycle. The illustration also shows how a graduated extraction of the momentarily required pressure medium can be made in a graduated fashion from the next higher bundle of cylinders with multistep groups 25a, 25b, 25c, . . . of storage cylinders with bundles of 70 bar, 140 bar, 210 bar and 280 bar, thus strongly minimising power dissipation. The illustration also shows how the charging L by means of charging pumps according to the pressure curve S can be avoided in conventional hydraulic storage units.

It is provided in a first operating mode to completely shut off individual storage cylinders or even partitions of storage cylinders 25a, 25b, 25c . . . . As a result, the energy requirements for charging the high-pressure hydraulic storage unit 25 is reduced to the output pressure and energy is advantageously saved.

It is alternatively provided in a second operating mode to re-pump the nitrogen to other existing groups of cylinders 25a, 25b, 25c . . . . If there are three groups of 600 L and 250 bar each, one group is discharged by means of the existing piston storage unit and additional valves to 70 bar, and two groups are filled in this process to 340 bar. The press is then operated with a group of 600 L and 70 bar. The two currently 340 bar groups are not required. This is based on real gas principles, according to which the storage effect of the gas at high pressures is clearly more unfavourable than at low pressures. If there is a change of tools to the tool with high force, the same pressure of 250 bar can be produced in all groups of cylinders 25a, 25b, 25c . . . by actuating the valve control unit.

A third operating mode provides a cascaded activation and deactivation of individual groups 25a, 25b, 25c . . . of storage cylinders.

It is possible with groups 25a, 25b, 25c . . . of storage cylinders which are adjustable to the operating modes that the press control unit automatically analyses capacity utilisation after the start of production and then accordingly blocks individual storage cylinders or even partitions 25a, 25b, 25c . . . of storage cylinders (operating mode 1) or refills the gas to the storage cylinders during the charging process at the end of the cycle (operating mode 2) or extracts the same in a cascaded fashion (operating mode 3). No waiting times or refilling times are advantageously required in all cases.

It is principally possible to dimension the hydraulic storage unit 25 in such a way that the hydraulic system can be operated in a more energy-efficient way in the case of variable spectrum of parts than was previously provided by the state of the art. In this respect, the storage unit 25 can be filled with a lower pressure of 70 bar for example. The volume is conveyed to the respective pressure level depending on the required reshaping force by means of a provided storage charging circuit.

This is also explained by reference to the following examples 1 to 3:

### EXAMPLE 1 WITH CURRENT CONFIGURATION

### Extraction 100 L

Preload pressure 270 bar
Size of storage reservoir 335 L
Gas volume 1800 L

### EXAMPLE 2 WITH NEW CONFIGURATION

### Extraction 100 L

Preload pressure 70 bar
Size of storage reservoir 5850 L
Gas volume 1800 L

### EXAMPLE 3 WITH NEW CONFIGURATION

### Extraction 100 L

Preload pressure 140 bar
Size of storage reservoir 2100 L
Gas volume 1800 L

In the case of configuring the storage unit to a preload pressure of 70 bar, the storage unit increases in size by 17 times in comparison with the previous configuration.

The present invention however proposes a stepped adjustment of the storage pressure to the required power demand (working pressure). This adjustment can preferably occur during a change of the tool which requires a different maximum force.

The following three pressure steps have proven to be successful:

| | | |
|---|---|---|
| 1^{st} step: | High forces | Preload pressure in the storage unit 210 bar |
| 2^{nd} step: | Medium forces | Preload pressure in the storage unit 140 bar |
| 3^{rd} step: | Lower forces | Preload pressure in the storage unit 70 bar |

Finally, FIG. 5 shows the bottom operating pressure as a function of active groups 25a, 25b, 25c . . . of nitrogen cylinders.

The present invention is finally illustrated by reference to the following aspects: presses were designed up until now for the maximum necessary pressure, e.g. forty cylinders as the pressure storage unit. All these cylinders always need to be charged fully, even when a batch is run with 5000 press strokes and only half the force.

An adaptive (self-learning) system is offered by the present invention. In the example of the 5000 parts which are run with a tool, the press control unit in a press in accordance with the invention will determine in a preferably automatic manner, e.g. after a specific number of (x) cycles, that even fewer storage cylinders in the hydraulic storage unit (gas storage unit) would be sufficient and reduces the filling pressure in one or several (X) cylinders or groups of storage cylinders according to one of the aforementioned operating modes.

The following calculation illustrates the advantages with respect to energy balance:

Maximum charging to 290 bar in 40 cylinders (more energy-intensive charging in the higher range, which means raising 40 cylinders from 250 bar to 290 bar is more expensive than in a lower pressure range or with fewer cylinders).

If the adaptive press control unit (i.e. the one that is adaptive and acts in an adaptive (self-learning) manner) determines that after x press cycles actually only 25 or 30 cylinders would be necessary, the remaining cylinders are charged and separated from the active cylinders (storage unit). They are still available for sudden maximum operation, but the cycles shown from experience give reason for assuming that even the next cycles (depending on the tool) can be run with the same necessary force. (1434)

### LIST OF REFERENCE NUMERALS: P1434

1 Ram
2 Piston
3 Cylinder
4 Annular space
5 Safety block
6 Pipelines
7 Proportional valve
8 Power source for cylinder-piston unit
9 Non-return valve
10 Low-pressure hydraulic storage unit
11 Pressure gauge
12 Switching valve
13 Tank
14 Control oil valve
15 Control oil line/control circuit supply
16 Release valve
17 Bypass valve
18 Non-return valve
19 Hydraulic pump
20 Auxiliary hydraulic circuit
21 Switching valve
22 Pipelines
23 Proportional valve
24 Release valve
25 High-pressure hydraulic storage unit, comprising at least two groups 25a, 25b, 25c, . . . of compressed gas storage cylinders
26 Hydraulic pump
p Pressure
P Working pressure curve of the press
a, b, c Pressure curves of groups 25a, 25b, 25c of storage cylinders in accordance with the invention
A, B, C Total pressure curve of a hydraulic storage unit 25 in accordance with
the invention
S Pressure curve of conventional hydraulic storage units
L Charging of conventional hydraulic storage units by hydraulic/charging pump(s)

1. A method for operating a hydraulic press used for the primary shaping, reshaping, punching or processing of materials or workpieces such as plastic moulding compounds, deep-drawing sheets, forged pieces or the like, comprising:
hydraulically actuating a hydraulic drive unit including a cylinder-piston unit for lifting and lowering a press ram, wherein a piston chamber of a cylinder of the drive unit is connected or connectable by hydraulic pipelines via a proportional valve and a release valve to a hydraulic storage unit formed by at least two groups of storage cylinders in such a way that an expansion volume stored by gas compression in the groups of storage cylinders directly or indirectly supplies the energy which is necessary for a working stroke of the press in a form of a volume flow and pressure via a piston storage unit, and wherein different filling pressures are producible in the groups of storage cylinders.

2. A method according to claim 1, wherein the groups of storage cylinders are filled in a graduated manner to the lowest possible pressure which is adjusted to a respective production requirement.

3. A method according to claim 1, wherein one group of storage cylinders is blocked in relation to another group of storage cylinders in a first operating mode in which the press is operated with a lower pressing force or a lower working stroke.

4. A method according to claim 1, wherein gas is re-pumped from an active group of storage cylinders to a non-active group of storage cylinders in a second operating mode in which the press requires a lower operating pressure or a lower extraction quantity.

5. A method according to claim 2, wherein a group of storage cylinders with a lowest filling pressure is connected at first to the piston chamber of the cylinder in a third operating mode, and with progressing working stroke a group of storage cylinders with a next higher filling pressure is operatively and sequentially connected to storage cylinders with gradually higher filling pressures.

6. A method according to claim 5, wherein activation of the next higher pressure-filled group of storage cylinders occurs shortly before reaching pressure equalization between a storage pressure and a working pressure in the piston chamber of the cylinder or when the piston falls beneath a required working stroke velocity thereof.

7. A method according to claim 5, wherein during activation of the next higher filled group of storage cylinders, a previously used group of storage cylinders is closed via a releasable non-return valve.

8. A method according to claim 7, wherein kinetic energy of a rapid closing movement of the ram is braked via closing cylinders before reaching a working stroke starting position, and a displacement volume and a braking pressure are used for filling the groups of storage cylinders.

9. A method according to claim 1, wherein a press control unit automatically analyses a capacity utilization of the press and controls the capacity utilization according to a required operating mode.

10. A hydraulic-press-operating apparatus adapted to operate a hydraulic press for the primary shaping, reshaping, punching or processing of materials or workpieces such as plastic moulding compounds, deep-drawing sheets, or forged pieces comprising:
a hydraulic drive unit including a cylinder-piston unit adapted to hydraulically lift and lower a press ram, wherein the cylinder-piston unit, including a piston, and a cylinder, is assigned a proportional valve, a release valve, and a hydraulic storage unit formed by at least two groups of storage cylinders that are adapted to be connected by pipelines, so that an expansion volume stored by gas compression in the groups of storage cylinders directly or indirectly supplies energy for a working stroke of the press in a form of a volume flow and pressure via a piston storage unit, and different filling pressures can be set in the groups of storage cylinders.
